(19) United States
(12) Patent Application Publication
(10) Pub. No.: US 2015/0235227 A1
(43) Pub. Date: Aug. 20, 2015

(54) PAYMENT METHOD BASED ON IDENTITY RECOGNITION AND WRIST-WORN APPARATUS

(71) Applicants: Li-Xiang Lee, Taipei City (TW); Kuan-Chien Chou, Taipei City (TW); Hao-Ying Chang, Taipei City (TW); Chien-Chun Wu, Taipei City (TW)

(72) Inventors: Li-Xiang Lee, Taipei City (TW); Kuan-Chien Chou, Taipei City (TW); Hao-Ying Chang, Taipei City (TW); Chien-Chun Wu, Taipei City (TW)

(73) Assignee: COMPAL ELECTRONICS, INC., Taipei City (TW)

(21) Appl. No.: 14/583,577

(22) Filed: Dec. 26, 2014

Related U.S. Application Data
(60) Provisional application No. 61/939,752, filed on Feb. 14, 2014.

(51) Int. Cl. G06Q 20/40; G06Q 20/32

(52) U.S. Cl. CPC G06Q 20/40145; G06Q 20/3227

(57) ABSTRACT

A payment method based on identity recognition and a wrist-worn apparatus are provided. A physiological state of a user wearing the wrist-worn apparatus is detected and a physiological characteristic is obtained by a physiological sensor. The physiological characteristic is compared with a preset characteristic for verifying identity of the user. When the physiological characteristic matches the preset characteristic, a payment action is executed.

### CROSS-REFERENCE TO RELATED APPLICATION

This application claims the priority benefits of U.S. provisional application Ser. No. 61/939,752, filed on Feb. 14, 2014. The entirety of the above-mentioned patent application is hereby incorporated by reference herein and made a part of this specification.

### BACKGROUND OF THE INVENTION

1. Field of the Invention

The invention generally relates to an identity verifying mechanism, and more particularly, to a payment method based on identity recognition and a wrist-worn apparatus.

2. Description of Related Art

A Point of Service (POS) is an electronic system, which has been broadly used in retail industry, restaurant industry, hotel industry and so forth, whereby a main function thereof lies in statistically counting product sale, inventory and customer buying behavior. Conventional POS combines a payment device for providing user with a function of proximal end payment transaction. That is, the user can use the payment device and the POS to perform a proximal end payment transaction. The POS will compare a timely detected biomarker with an internal registered referential biomarker in the payment device to obtain an authorization for performing a payment operation. However, this approach requires that the biomarker of the user to be registered in the POS, such that an establishment procedure is difficult, and the process of comparison is also complicated.

### SUMMARY OF THE INVENTION

The invention is directed to a payment method based on identity recognition and a wrist-worn apparatus capable of executing a payment action after verifying a user identity.

The payment method based on identity recognition of the invention is suitable for a wrist-worn apparatus. This payment method includes the following steps. Under a condition whereby the user is wearing the wrist-worn apparatus, a physiological sensor is driven to detect a physiological state of the user wearing the wrist-worn apparatus, so as to obtain a physiological characteristic of the user. The physiological characteristic is compared with a preset characteristic for verifying an identity of the user. When the physiological characteristic matches the preset characteristic, the payment action is executed.

In one embodiment of the invention, when the wrist-worn apparatus is not being worn on the user body, the physiological sensor is disabled.

In one embodiment of the invention, before comparing the physiological characteristic with the preset characteristic, the payment method based on identity recognition further includes: determining whether a pay command is received; and when the pay command is received, switching to a mobile payment mode, so as to compare the physiological characteristic with the preset characteristic under the mobile payment mode.

In one embodiment of the invention, after comparing the physiological characteristic with the preset characteristic, the method based on identity recognition further includes: determining whether a pay command is received; and when the pay command is received while the physiological characteristic matches the preset characteristic, switching to a mobile payment mode, so as to execute the payment action under the mobile payment mode.

In one embodiment of the invention, the payment method based on identity recognition further includes: detecting whether a press command is received, so as to execute the physiological sensor to obtain the physiological characteristic upon receiving the press command.

In one embodiment of the invention, the step of obtaining the physiological characteristic includes: capturing an inner wrist image of the user by the physiological sensor; and executing an image recognition program to obtain a blood vessel shape characteristic from the inner wrist image, and using the blood vessel shape characteristic as the physiological characteristic.

In one embodiment of the invention, the payment method based on identity recognition further includes: obtaining a blood vessel image of entire wrist region of the user in advance through using the physiological sensor, so as to execute the image recognition program for obtaining the preset characteristic from the blood vessel image.

In one embodiment of the invention, the physiological sensor includes a light-emitting unit and an optical detector, and the physiological characteristic is a blood vessel shape characteristic or a skin characteristic. The physiological state includes at least one of blood pressure data, blood oxygen data, heartbeat data and pulse data.

In one embodiment of the invention, the payment method based on identity recognition further includes: when the physiological state does not comply with a standard state, sending an emergency signal to inform a medical center or an emergency contact person through a network service.

In one embodiment of the invention, the payment method based on identity recognition further includes: when the physiological characteristic does not match the preset characteristic, sending out a warning signal and stop executing the payment action.

The wrist-worn apparatus of the invention includes a storage unit, a physiological sensor and a control unit. The storage unit is stored with a preset characteristic. The physiological sensor is configured to detect a physiological state of the user wearing the wrist-worn apparatus and to obtain a physiological characteristic of the user. The control unit is coupled to the storage unit and the physiological sensor.

At this moment, the control unit compares the physiological characteristic with the preset characteristic for verifying an identity of the user.

In one embodiment of the invention, the wrist-worn apparatus further includes: a mobile payment unit coupled to the control unit for executing a payment action. At this moment, the control unit sends a payment execution command the mobile payment unit when determining that the physiological characteristic matches the preset characteristic, so that the mobile payment unit executes the payment action.

In one embodiment of the invention, the control unit determines whether a pay command is received before comparing the physiological characteristic with the preset characteristic, and when the pay command is received, the control unit switches to mobile payment mode, so as to compare the physiological characteristic with the preset characteristic under the mobile payment mode. Otherwise, the control unit determines whether a pay command is received after comparing the physiological characteristic with the preset characteristic, and when the pay command is received while the physiological characteristic matches the preset characteristic, the control unit switches to the mobile payment mode, so as to execute the payment action under the mobile payment mode.

In one embodiment of the invention, the wrist-worn apparatus further includes a pressure detector coupled to the control unit for detecting whether a press command is received, so as to drive the physiological sensor to obtain the physiological characteristic of the user upon receiving the press command.

In one embodiment of the invention, the physiological sensor captures an inner wrist image of the user, and the control unit executes an image recognition program to obtain a blood vessel shape characteristic from the inner wrist image, so as to use the blood vessel shape characteristic as the physiological characteristic.

In one embodiment of the invention, the physiological sensor obtains a blood vessel image of entire wrist region of the user in advance and enables the control unit to execute the image recognition program to obtain the preset characteristic from the blood vessel image.

In one embodiment of the invention, the wrist-worn apparatus further includes a communication unit and a warning unit. The communication unit is coupled to the control unit. When the physiological state does not comply with a standard state, the control unit sends an emergency signal to inform a medical center or an emergency contact person through the communication unit. The warning unit is coupled to the control unit. When the physiological characteristic does not match the preset characteristic, the warning unit sends out a warning signal.

In one embodiment of the invention, the wrist-worn apparatus further includes a judgment unit. The judgment unit determines whether the wrist-worn apparatus is being worn on the user. If the wrist-worn apparatus is determined as being worn on the user, then the physiological sensor is driven to detect the physiological state and the physiological characteristic of the user; and if the wrist-worn apparatus is determined as not being worn on the user, then the physiological sensor or the mobile payment unit is to be disabled.

In one embodiment of the invention, the judgment unit is the physiological sensor, and when the physiological sensor is unable to determine the physiological state the wrist-worn apparatus is determined as not being worn on the user.

In view of the foregoing, the physiological state of the user may be continuously detected by the wrist-worn apparatus, and the physiological characteristic of the user may further be obtained for performing identity verification, so as to ensure that a mobile payment action will not be misappropriated by an unauthorized person.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are block diagrams illustrating a wrist-worn apparatus according to a first embodiment of the invention.

FIG. 2 is a schematic diagram illustrating a method for wearing the wrist-worn apparatus according to the first embodiment of the invention.

FIG. 3 is a flow chart illustrating a payment method based on identity recognition according to the first embodiment of the invention.

FIG. 4 is a block diagram illustrating another wrist-worn apparatus according to the first embodiment of the invention.

FIG. 5 is a flow chart illustrating a payment method based on identity recognition according to a second embodiment of the invention.

FIG. 6 is a flow chart illustrating a payment method based on identity recognition according to a third embodiment of the invention.

### DESCRIPTION OF THE EMBODIMENTS

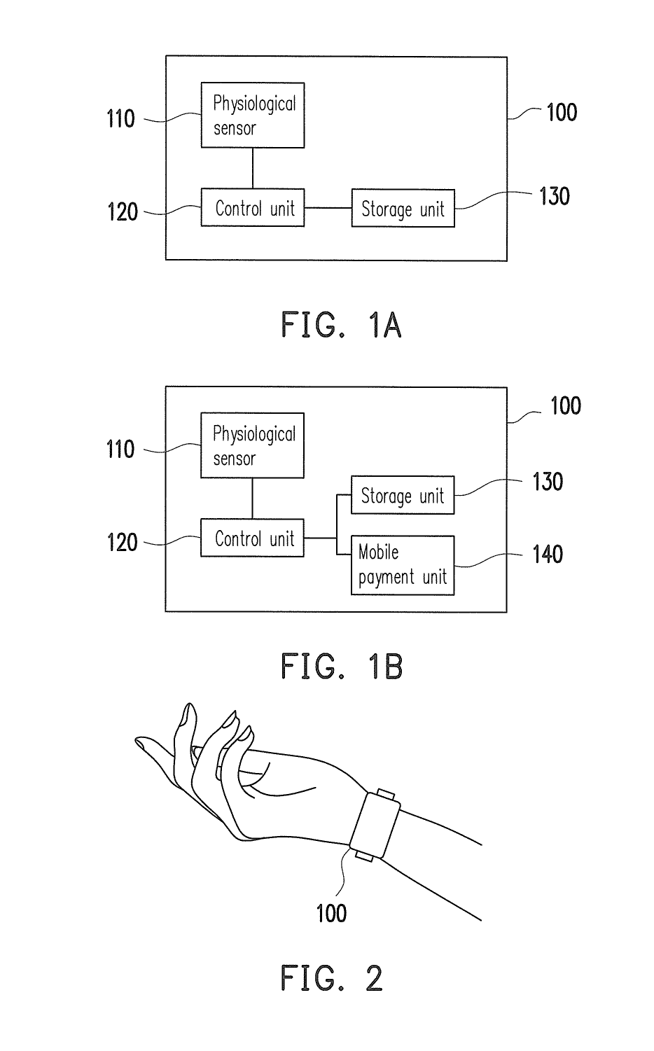

FIG. 1A and FIG. 1B are block diagrams illustrating a wrist-worn apparatus 100 according to a first embodiment of the invention. FIG. 2 is a schematic diagram illustrating a method for wearing the wrist-worn apparatus according to the first embodiment of the invention. In FIG. 1A, the wrist-worn apparatus 100 includes a physiological sensor 110, a control unit 120 and a storage unit 130. The wrist-worn apparatus 100 is being worn on a wrist of a user, so as to detect a physiological state of the user and to obtain a physiological characteristic of the user, as shown in FIG. 2. The physiological sensor 110 is configured to detect the physiological state of the user wearing the wrist-worn apparatus 100 and to obtain the physiological characteristic of the user. The control unit 120 is coupled to the physiological sensor 110 and the storage unit 130. The control unit 120 drives the physiological sensor 110 to obtain the physiological characteristic of the user and compares the physiological characteristic with a preset characteristic for verifying an identity of the user, thereby sending out a payment execution command when the physiological characteristic matches the preset characteristic. The storage unit 130 is stored with the preset characteristic related to the user.

Herein, the physiological state includes at least one of blood pressure data, blood oxygen data and heartbeat/pulse data. The physiological characteristic is, fore example, a blood vessel shape characteristic or a skin characteristic. The blood vessel shape characteristic is, for example, blood vessel shape distribution. The skin characteristic is, fore example, skin texture.

The physiological sensor 110 includes a light-emitting unit and an optical detector. Light emitted by the light-emitting unit may irradiate on the user's inner wrist, and thus the optical detector may capture an inner wrist image of the user. Then, the control unit 120 executes an image recognition program to obtain the blood vessel shape characteristic, such as a vein shape, from the inner wrist image, so as to use the blood vessel shape characteristic as the physiological characteristic.

In addition, when the light emitted by the light-emitting unit of the physiological sensor 110 irradiates on the wrist, because body tissues (e.g.: oxygenated haemoglobin and deoxygenated haemoglobin in the blood vessel) have different characteristics with respect to different degrees of light absorption, reflection or penetration, the optical detector may detect these differences and perform further calculations by using the control unit 120, so as to produce physiological state data, such as the blood pressure data, the blood oxygen data or the heartbeat/pulse data.

The control unit 120 is, for example, a central processing unit (CPU) or other programmable microprocessor, a digital signal processor (DSP), a programmable controller, an application specific integrated circuit (ASIC), a system on chip (SoC), other similar element, or a combination thereof The storage unit 130 is, for example a non-volatile memory, a random access memory (RAM) or a hard drive. The above listings are only provided as examples; and the invention is not limited thereto.

In FIG. 1B, the wrist-worn apparatus 100 further includes a mobile payment unit 140 for executing a payment action after the identity is verified by the control unit 120. The mobile payment unit 140 is coupled to the control unit 120 for executing the payment action upon receiving the payment execution command. The mobile payment unit 140 is, for example, a near field communication (NFC) chip, a radio frequency identification (RFID) chip, a single wire protocol (SWP) chip, a bluetooth low energy (BLE) chip, so forth.

Each step of the payment method based on identity recognition, accompanied by the wrist-worn apparatus 100, is described in the following below.

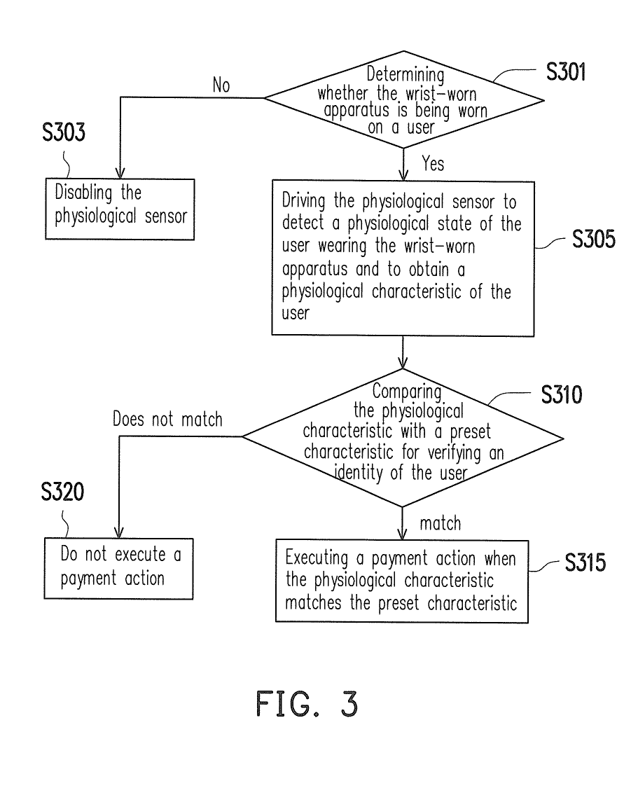

FIG. 3 is a flow chart illustrating a payment method based on identity recognition according to the first embodiment of the invention. Referring to FIG. 3, in step S301, it is to determine whether the wrist-worn apparatus 100 is being worn on the user. For instance, in the present embodiment, the physiological sensor 110 may be used to determine whether the wrist-worn apparatus 100 is being worn on the human body. For instance, when the physiological sensor 110 unable to obtain the physiological state, then the control unit 120 determines that the wrist-worn apparatus 100 is not being worn on the user body. In other embodiment, a judgment unit may additionally be configured in the wrist-worn apparatus 100, and the judgment unit may determine whether the wrist-worn apparatus 100 is being worn on the human body.

Under a condition that the wrist-worn apparatus 100 is not being worn on the user body, in step S303, the control unit 120 disables the physiological sensor 110, such as turning off a sensing function of the physiological sensor 110. Under a condition that the user is wearing the wrist-worn apparatus 100, in step S305, the control unit 120 drives the physiological sensor 110 to detect the physiological state of the user wearing the wrist-worn apparatus 100 and to obtain the physiological characteristic of the user.

For instance, after the wrist-worn apparatus 100 is being worn on the user's wrist, the control unit 120 of the wrist-worn apparatus 100 automatically drives the physiological sensor 110 to obtain the physiological state and the physiological characteristic of the user.

For instance, the user may allow the wrist-worn apparatus 100 to get close to the skin through pressing, and the control unit 120 would drive the physiological sensor 110 upon receiving a press command, so that the physiological sensor 110 can obtain the physiological characteristic of the user. Because each person has a different blood vessel shape, venous blood vessel shape may be used for recognition of the identity. Herein, in terms that the physiological characteristic is the blood vessel shape characteristic, the physiological sensor 110 would capture the inner wrist image of the user, whereby the captured inner wrist image may only include blood vessels at the wrist. The user may adjust a position of the wrist-worn apparatus 100 on the wrist, so that the physiological sensor 110 can obtain the inner wrist image accurately. After obtaining the inner wrist image, the control unit 120 executes the image recognition program to obtain the blood vessel shape characteristic from the inner wrist image. In the present embodiment, a venous blood vessel shape characteristic is being used as the physiological characteristic, but the invention is not limited thereto.

Moreover, before wearing the wrist-worn apparatus 100 on the wrist of the user, a preset characteristic corresponding to the user may be pre-established into the wrist-worn apparatus 100 by a vendor; or the user may personally pre-establish his/her preset characteristic by using the wrist-worn apparatus 100 and store the preset characteristic into the storage unit 130 of the wrist-worn apparatus 100. For instance, a blood vessel image of entire wrist region of the user may be obtained in advance through using the physiological sensor 110, so that the control unit 120 may execute the image recognition program to obtain the preset characteristic from the blood vessel image. That is, a physiological characteristic corresponding to the user is pre-established in the wrist-worn apparatus 100 as the preset characteristic. Herein, the blood vessel image of entire wrist region of the user includes a blood vessel distribution of the entire wrist. Later on, it only requires capturing an inner wrist image including parts of the blood vessels to compare with the blood vessel image of entire wrist region.

Next, in step S310, the control unit 120 compares the physiological characteristic with the preset characteristic for verifying the identity of the user. For instance, a vein recognition algorithm may be used to verify whether the blood vessel shape characteristic obtained from the inner wrist image matches the preset characteristic stored in the storage unit 130. That is, a timely obtained physiological characteristic is being compared with a preset physiological characteristic for determining whether the user is an authorized user.

When the physiological characteristic matches the preset characteristic, it indicates that an identity verification of the user is successful, as shown in step S315, and then the payment action is executed by the mobile payment unit 140. For instance, when the physiological characteristic matches the preset characteristic, the control unit 120 sends a payment execution command to the mobile payment unit 140, so as to enable the mobile payment unit 140 to execute the payment action. When the physiological characteristic does not match the preset characteristic, it indicates that the identity verification of the user fails, which means that the user currently wearing the wrist-worn apparatus 100 is not an authorized user, such as shown in S320, and the wrist-worn apparatus 100 does not execute the payment action. In addition, in step S320, the control unit 120 may further send out a warning signal to inform the user, such as, using the warning signal to inform the user about the failure of a mobile payment.

Moreover, when detects that the wrist-worn apparatus 100 is not being worn on the user body, in the step S303, the control unit 120 may disable both or any one of the physiological sensor 110 and the mobile payment unit 140. For instance, after the user has removed the wrist-worn apparatus 100 from the wrist, the control unit 120 will not obtain the physiological state and the physiological characteristic from the physiological sensor 110, and thus the wrist-worn apparatus 100 will be determined as being removed from the user body; and as a result, the control unit 120 may further disable the physiological sensor 110 to reduce power consumption, and may also further disable the mobile payment unit 140 to prevent a false action in the mobile payment unit 140. The above descriptions are provided only as examples, whereby the invention is not limited thereto.

Moreover, in the present embodiment, health status of the user may be continuously observed and recorded through using the physiological sensor 110. For instance, the blood pressure data, the blood oxygen data or the heartbeat/pulse data of the user may be continuously detected by the physiological sensor 110, and the detected physiological state may be recorded in the storage unit 130. In addition, when the control unit 120 determines that the detected physiological state does not comply with the standard state, an emergency signal may further be sent out through a network service for informing the medical center or the emergency contact person. For instance, the control unit 120 sends the emergency signal to a medical center server or an electronic device used by the emergency contact person, such as a mobile phone or a tablet PC, through the network service.

In addition to the components shown in FIG. 1A and FIG. 1B, the wrist-worn apparatus 100 may further selectively include an input unit, a warning unit, a display unit, a communication unit, and a pressure detector. The following provides another embodiment of the invention.

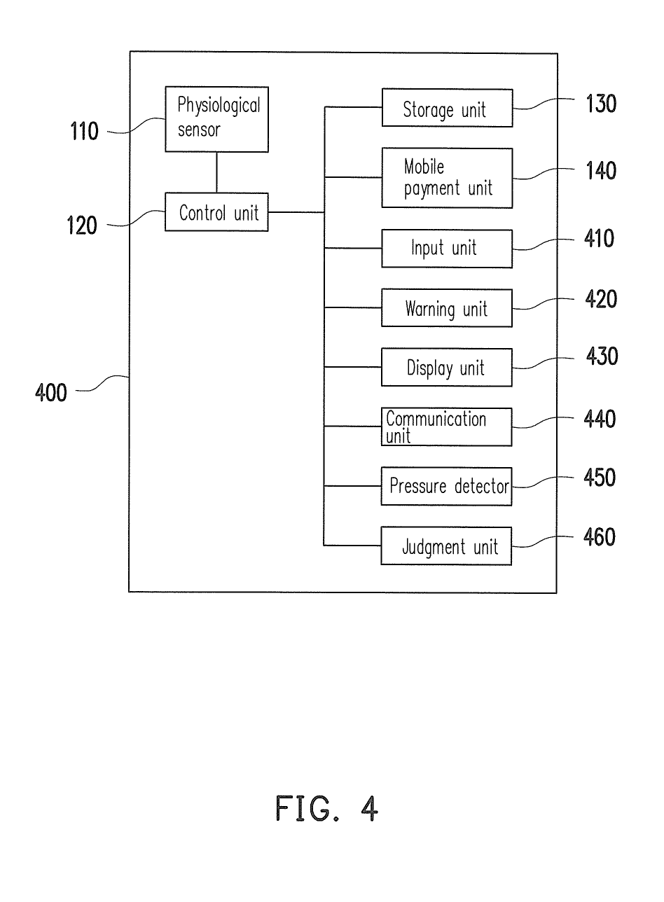

FIG. 4 is a block diagram illustrating another wrist-worn apparatus 400 according to the first embodiment of the invention. In addition to a physiological sensor 110, a control unit 120, a storage unit 130 and a mobile payment unit 140, the wrist-worn apparatus 400 further includes an input unit 410, a warning unit 420, a display unit 430, a communication unit 440, and a pressure detector 450. The physiological sensor 110, the storage unit 130, the mobile payment unit 140, the input unit 410, the warning unit 420, the display unit 430, the communication unit 440, and the pressure detector 450 are respectively coupled to the control unit 120. Herein, components with similar functions to that of the wrist-worn apparatus 100 are indicated with same reference numerals, and descriptions regarding those components will not be repeated.

In FIG. 4, the input unit 410 is, for example, a push switch or a touch interface, such that the user may input a pay command through the input unit 410. In other embodiments, a pay command may also be generated by the mobile payment unit 140 when the wrist-worn apparatus 400 is getting close to a payment platform, such as a point of service (POS) of the vendor.

The warning unit 420 is configured to send out a warning signal when the physiological characteristic does not match the preset characteristic, such as displaying the warning signal in the display unit 430. Moreover, the warning unit 420 may be a light-emitting unit, and the warning signal may, for example, be a light-emitting signal.

Otherwise, the warning unit 420 may be a speaker, and the warning signal may, for example, be a sound signal.

The display unit 430 may display the detected physiological state, or display payment information of the payment action. The display unit 430 may also be a touch screen integrated with a touch module.

The communication unit 440 is, for example, an equipment configured to provide a wired transfer protocol or a wireless transmission protocol, and the wrist-worn apparatus 400 is able to connect to the network service through the communication unit 440. When the physiological state does not comply with the standard state, the control unit 120 sends out an emergency signal to inform the medical center or the emergency contact person through the communication unit 440.

The pressure detector 450 is configured to detect whether a press command is received, so that the control unit 120 may drive the physiological sensor 110 to obtain the physiological characteristic upon receiving the press command. The pressure detector 450 is, for example, disposed at a same side as the physiological sensor, and is configured to detect whether the user has apply a pressing force to the wrist-worn apparatus 400 and to whether the press command is received.

The wrist-worn apparatus 400 further includes a judgment unit 460. The judgment unit 460 is used for determining whether the wrist-worn apparatus 400 is being worn on the user body. If it is determined that the wrist-worn apparatus 400 is being worn on the user body, then the control unit 120 drives the physiological sensor 110 to detect the physiological state and the physiological characteristic of the user; contrarily, if it is determined that the wrist-worn apparatus 400 is not being worn on the user body, then the control unit 120 turns off the physiological sensor 110 or the mobile payment unit 140.

In other embodiments, the physiological sensor 110 may replace the judgment unit 460 for determining whether the wrist-worn apparatus 400 is being worn on the user body. For instance, when the physiological sensor 110 unable to obtain the physiological state, then the wrist-worn apparatus 400 is being determined as not being worn on the user body. In terms that the physiological sensor 110 is being used as the judgment unit while the physiological sensor 110 has a function for obtaining the physiological state and a function for obtaining the physiological characteristic, and in addition, assuming that, in the physiological sensor 110, the function for obtaining the physiological state is enabled and the function for obtaining the physiological characteristic is disabled, then after the user has put on the wrist-worn apparatus 400, the physiological sensor 110 may continuously obtain the physiological state of the user, such as the blood pressure data, the blood oxygen data or the heartbeat/pulse data, so that the control unit 120 can know that the wrist-worn apparatus 400 is already being worn on a user body. Accordingly, the control unit 120 may further enable the function for obtain the physiological characteristic in the physiological sensor 110. For instance, the control unit 120 may directly enable the function for obtaining the physiological characteristic in the physiological sensor 110, or the control unit 120 may drive the physiological sensor 110 to obtain the physiological characteristic only when the pressure detector 450 receives the press command.

In the following, a second embodiment and a third embodiment are provided for illustrating the orders of receiving the pay command and verifying the identity by the wrist-worn apparatus 100.

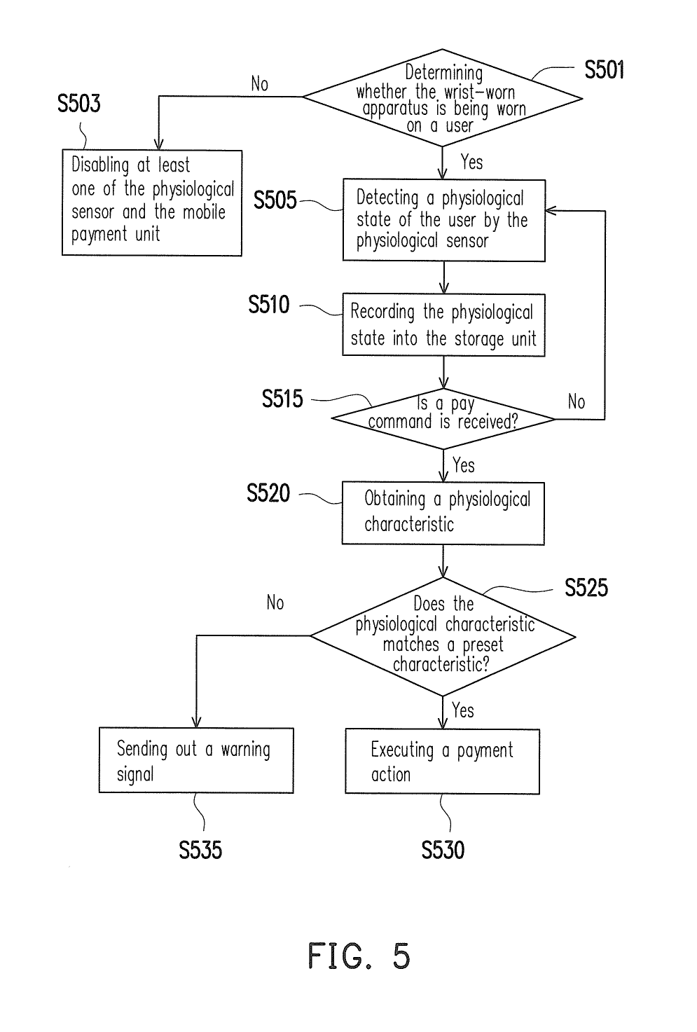

FIG. 5 is a flow chart illustrating a payment method based on identity recognition according to a second embodiment of the invention. Referring to FIG. 4 and FIG. 5 at the same time, in step S501, the judgment unit 460 determines whether the wrist-worn apparatus 400 is being worn on the user body. Under the condition that the wrist-worn apparatus 400 is not being worn on the user body, in step S503, the control unit 120 disables at least one of the physiological sensor 110 and the mobile payment unit 140. Under the condition that the wrist-worn apparatus 400 is being worn on the user body, the control unit 120 enables the physiological sensor 110 to execute step S505.

In the step S505, the physiological sensor 110 detects the physiological state of the user. Next, in step S510, the physiological state is recorded into the storage unit 130. Afterward, in step S515, the control unit 120 determines whether a pay command is received. If the pay command is not received, then returns to the step S505, and continuously detects the physiological state of the user by the physiological sensor 110. If the pay command is received, then the control unit 120 is switched into the mobile payment mode so as to compare physiological characteristic with the preset characteristic under the mobile payment mode. Namely, in step S520, the control unit 120 obtains the physiological characteristic.

Herein, upon receiving the pay command, the control unit 120 drives the physiological sensor 110 to capture an inner wrist image of the user, so as to obtain a blood vessel shape characteristic, which can be used as the physiological characteristic, from the inner wrist image. Moreover, the wrist-worn apparatus 400 may be designed as follows: that is, the mobile payment unit 140 generates the pay command upon receiving the press command, so as to enable the control unit 120 to drive the physiological sensor 110 to obtain the physiological characteristic of user.

Then, in step S525, the control unit 120 compares whether the physiological characteristic matches the preset characteristic under the mobile payment mode. If the physiological characteristic matches the preset characteristic, then it indicates that the user currently wearing the wrist-worn apparatus 400 has an authority for executing the payment action; and therefore, step S530 is to be executed, whereby the payment action is execute by the mobile payment unit 140.

If the physiological characteristic does not match the preset characteristic, then it indicates that the user currently wearing the wrist-worn apparatus 400 does not have an authority for executing the payment action; and therefore, step S535 is executed, whereby a warning signal is being sent out by the warning unit 420. In addition, the warning signal may further be sent to a preset electronic apparatus by the communication unit 440 through the network service.

In the second embodiment, after determining that the pay command is received, the wrist-worn apparatus 400 is switched to the mobile payment mode, so as to verify the user identity under the mobile payment mode. That is to say, in the second embodiment, physiological characteristic comparison has to be performed for every payment action.

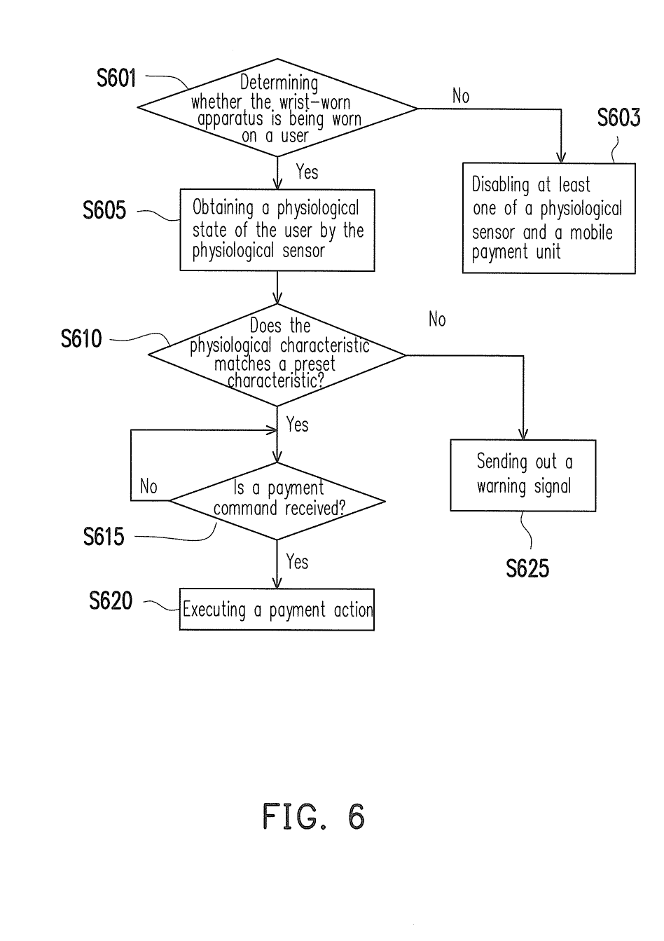

FIG. 6 is a flow chart illustrating a payment method based on identity recognition according to a third embodiment of the invention. Referring to FIG. 4 and FIG. 6 at the same time, in step S601, the judgment unit 460 determines whether the wrist-worn apparatus 400 is being worn on the user body. Under the condition that the wrist-worn apparatus 400 is not being worn on the user body, in step S603, the control unit 120 disables at least one of the physiological sensor 110 and the mobile payment unit 140. Under the condition that the wrist-worn apparatus 400 is being worn on the user, the control unit 120 enables the physiological sensor 110, so as to execute step S605.

In the step S605, the physiological state of the user is obtained by the physiological sensor 110. Next, in step S610, the control unit 120 compares whether the physiological characteristic matches the preset characteristic. After comparing the physiological characteristic with the preset characteristic, as shown in step S615, the control unit 120 determines whether a pay command is received. When the pay command is received and the physiological characteristic matches the preset characteristic, the control unit 120 switches to the mobile payment mode, so as to execute the payment action under the mobile payment mode, as shown in step S620.

If in the step S610, the physiological characteristic is determined as not matching the preset characteristic, then it indicates that the user currently wearing the wrist-worn apparatus 400 does not have an authority for executing the payment action, and thus, as shown in step S625, a warning signal is being sent out by the warning unit 420.

In the third embodiment, verification of the user identity would immediately be performed once the wrist-worn apparatus 400 is being worn on the user, and when the verification of the user identity is successful and when the pay command is received subsequently, the comparison of the physiological characteristic is not required to be performed again. When the user takes down and re-wears the wrist-worn apparatus 400, the wrist-worn apparatus 400 would then perform the comparison of the physiological characteristic again.

Moreover, in the first embodiment through the third embodiment, when the wrist-worn apparatus 100 (or the wrist-worn apparatus 400) is being worn on the user A, the comparison of the physiological characteristic may firstly be performed. The wrist-worn apparatus 100 may know that a currently wearer is user A through the comparison result, and the physiological sensor 110 of the wrist-worn apparatus 100 would continuously detect the physiological state and record the physiological state into the storage unit 130 as a physiological state of the user A. The control unit 120 would also enable the mobile payment unit 140 to allow the user A to perform a mobile payment action. If the wrist-worn apparatus 100 (or the wrist-worn apparatus 400) is removed being from the user A, then the mobile payment unit 140 would be disabled and the physiological sensor 110 would also be stop (disabled), and thus unable to record the physiological state. When the wrist-worn apparatus 100 (or the wrist-worn apparatus 400) is being worn on the user again, then the comparison of the physiological characteristic would be executed again, so as to verify whether the identity of the wearer is legal.

In addition, the storage unit 130 may also have a plurality of preset characteristics for enabling the verification of a plurality of users. As a result, the wrist-worn apparatus 100 (or the wrist-worn apparatus 400) may be worn by different users, so as to respectively record the physiological state of each user and perform individual mobile payment action.

In summary, the wrist-worn apparatus, in addition to continuously detecting the physiological state of the user for observing and recording the health condition of the user, may further obtain the physiological characteristic of the user for performing the verification of the user identity through using the physiological characteristic. That is, the wrist-worn apparatus simultaneously has the function of detecting the physiological state and the function of identifying the physiological characteristic, so as to verify the user identity through using the physiological characteristic, thereby making sure that the payment action of the mobile payment unit will not be performed by an unauthorized person.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A payment method based on identity recognition suitable for a wrist-worn apparatus, the payment method comprising:
under a condition whereby a user is wearing the wrist-worn apparatus, driving a physiological sensor a physiological state of the user wearing the wrist-worn apparatus, and obtaining a physiological characteristic of the user;
comparing the physiological characteristic with a preset characteristic for verifying an identity of the user; and
executing a payment action when the physiological characteristic matches the preset characteristic.

2. The payment method based on identity recognition as recited in claim 1, further comprising:
disabling the physiological sensor when detects that the wrist-worn apparatus is not being worn on the user.

3. The payment method based on identity recognition as recited in claim 1, wherein, before the step of comparing the physiological characteristic with the preset characteristic, further comprises:
determining whether a pay command is received; and
switching to a mobile payment mode when the pay command is received, so as to compare the physiological characteristic with the preset characteristic under the mobile payment mode.

4. The payment method based on identity recognition as recited in claim 1, wherein, after the step of comparing the physiological characteristic with the preset characteristic, further comprises:
determining whether a pay command is received; and
switching to a mobile payment mode when the pay command is received while the physiological characteristic matches the preset characteristic, so as to execute the payment action under the mobile payment mode.

5. The payment method based on identity recognition as recited in claim 1, further comprising:
detecting whether a press command is received, so as to drive the physiological sensor to obtain the physiological characteristic upon receiving the press command.

6. The payment method based on identity recognition as recited in claim 1, wherein the step of obtaining the physiological characteristic of the user comprises:
capturing an inner wrist image of the user by the physiological sensor; and
executing an image recognition program to obtain a blood vessel shape characteristic from the inner wrist image, and using the blood vessel shape characteristic as the physiological characteristic.

7. The payment method based on identity recognition as recited in claim 6, further comprising:
obtaining a blood vessel image of entire wrist region of the user in advance through using the physiological sensor; and
executing the image recognition program to obtain the preset characteristic from the blood vessel image.

8. The payment method based on identity recognition as recited in claim 1, wherein the physiological sensor comprises a light-emitting unit and an optical detector, the physiological characteristic is a blood vessel shape characteristic or a skin characteristic, and the physiological state comprises at least one of blood pressure data, blood oxygen data, heartbeat data and pulse data.

9. The payment method based on identity recognition as recited in claim 1, further comprising:
sending an emergency signal to inform a medical center or an emergency contact person through a network service when the physiological state does not comply with a standard state.

10. The payment method based on identity recognition as recited in claim 1, further comprising:
sending out a warning signal and stop executing the payment action when the physiological characteristic does not match the preset characteristic.

11. A wrist-worn apparatus, comprising:
a storage unit, storing a preset characteristic;
a physiological sensor, detecting a physiological state of a user wearing the wrist-worn apparatus, and obtaining a physiological characteristic of the user; and
a control unit, coupled to the storage unit and the physiological sensor, wherein the control unit compares the physiological characteristic with the preset characteristic for verifying an identity of the user.

12. The wrist-worn apparatus as recited in claim 11, further comprising:
a mobile payment unit, coupled to the control unit for executing a payment action, wherein the control unit sending a payment execution command to the mobile payment unit when determining that the physiological characteristic matches the preset characteristic, so that the mobile payment unit executes the payment action.

13. The wrist-worn apparatus as recited in claim 12, wherein
the control unit determines whether a pay command is received before comparing the physiological characteristic with the preset characteristic, and when the pay command is received, the control unit switches to mobile payment mode, so as to compare the physiological characteristic with the preset characteristic under the mobile payment mode; or
the control unit determines whether a pay command is received after comparing the physiological characteristic with the preset characteristic, and when the pay command is received while the physiological characteristic matches the preset characteristic, the control unit switches to the mobile payment mode, so as to execute the payment action under the mobile payment mode.

14. The wrist-worn apparatus as recited in claim 11, further comprising:
a pressure detector, coupled to the control unit for detecting whether a press command is received, and driving the physiological sensor to obtain the physiological characteristic of the user upon receiving the press command.

15. The wrist-worn apparatus as recited in claim 11, wherein the physiological sensor captures an inner wrist image of the user, and the control unit executes an image recognition program to obtain a blood vessel shape characteristic from the inner wrist image, so as to use the blood vessel shape characteristic as the physiological characteristic.

16. The wrist-worn apparatus as recited in claim 15, wherein the physiological sensor obtains a blood vessel image of entire wrist region of the user in advance and enables the control unit to execute the image recognition program to obtain the preset characteristic from the blood vessel image.

17. The wrist-worn apparatus as recited in claim 11, wherein the physiological sensor comprises a light-emitting unit and an optical detector, the physiological characteristic comprises a blood vessel shape characteristic or a skin characteristic, and the physiological state comprises at least one of blood pressure data, blood oxygen data, heartbeat data and pulse data.

18. The wrist-worn apparatus as recited in claim 11, further comprising:
a communication unit, coupled to the control unit, wherein when the physiological state does not comply with a standard state, the control unit sends an emergency signal to inform a medical center or an emergency contact person through the communication unit; and
a warning unit, coupled to the control unit, and sending out a warning signal when the physiological characteristic does not match the preset characteristic.

19. The wrist-worn apparatus as recited in claim 12, further comprising:
a judgment unit, determining whether the wrist-worn apparatus is being worn on the user, driving the physiological sensor to detect the physiological state and the physiological characteristic of the user if determining that the wrist-worn apparatus is being worn on the user, and disabling the physiological sensor or the mobile payment unit if determining that the wrist-worn apparatus is not being worn on the user.

20. The wrist-worn apparatus as recited in claim 19, wherein the judgment unit is the physiological sensor, and when the physiological sensor is unable to determine the physiological state, the wrist-worn apparatus is determined as not being worn on the user.
